(19) United States
(12) Patent Application Publication
(10) Pub. No.: US 2022/0312777 A1
(43) Pub. Date: Oct. 6, 2022

(54) Device For Applying Scatterable Material

(71) Applicant: König Maschinen Gesellschaft m.b.H., Graz (AT)

(72) Inventors: Thomas Palzer, Deutschfeistritz (AT); Thomas Rieger, Lieboch (AT); Peter Thomasser, Gleisdorf (AT)

(21) Appl. No.: 17/629,623

(22) PCT Filed: Jul. 24, 2020
(86) PCT No.: PCT/AT2020/060276

§ 371 Date: Jan. 24, 2022

(30) Foreign Application Priority Data
Jul. 26, 2019 (AT) A50681/2019

(51) Int. Cl. A21C 9/04; A21C 3/08

(52) U.S. Cl. CPC A21C 9/04; A21C 3/08

(57) ABSTRACT

The present teaching relates to a device for applying scatterable material, in particular poppy or sesame, to the bottom of pieces of dough. It includes a covering belt for transporting the pieces of dough from a dough receiving point to a dough dispensing point, it being possible to receive pieces of dough not sprinkled on the bottom thereof onto the covering belt at the dough receiving point and to dispense pieces of dough sprinkled on the bottom thereof from the covering belt at the dough dispensing point. A scatterable-material unit holds and applies the scatterable material, which scatterable-material unit is arranged below the transport plane. A transport belt is arranged at least partly below the scatterable-material unit, it being possible to apply scatterable material to the transport belt by means of the scatterable-material unit,

### TECHNICAL FIELD

The present teaching relates to a device for applying dispersible or scatterable material to pieces of dough, or pastries, and a dough installation or installation for pastries comprising such a device.

### BACKGROUND

Devices for dispersing material onto pastries or pieces of dough are known in the prior art. Such devices usually entail a great deal of cleaning effort and require considerable space. In most cases, the dispersible or scatterable material is applied to the pastries or dough pieces from above. Application of the dispersible or scatterable material can lead to random scattering of the dispersible or scatterable material, causing a very great demand for clean-up and the loss of dispersible or scatterable material. It is necessary to moisten the dough pieces or pastries in advance in order to allow adhesion of the dispersible material to the pastries or dough pieces. It is essential to moisten the pastries or dough pieces uniformly in order to achieve uniform adhesion of the dispersible or scatterable material, an excess of water being thereby required, said excess water being spread onto the succeeding installation components, causing problems both for the operation of the installation and for cleaning.

In addition, excess dispersible or scatterable material, which merely is in contact with the pastries or dough pieces but does not adhere to the dough pieces, is spread onto the successive installation components. This causes problems particularly when there is alternation between various types of dispersible or scatterable material, which can result in such cases in undesired mixing of the various dispersible or scatterable material. As a result of the random scattering and spreading of the dispersible or scatterable material, cleaning of the installation parts again becomes substantially difficult and there is an increase in the amount of dispersible or scatterable material which as refuse is no longer usable.

### SUMMARY

It is therefore one object of the present teaching to provide a device for applying scatterable material on pastries or dough pieces which comprises a compact space requirement, minimizes cleaning needs and makes possible uniform or selective distribution of the dispersing or scattering material on the pastries or dough pieces.

The present teaching fulfills the object. The inventive device for applying dispersible or scatterable material, particularly dispersible or scatterable material relevant for pastries such as poppyseeds, sesame seeds, sunflower seeds, oats, semolina, grain scrap material, grated cheese and so on, to the bottom of pastries or dough pieces, comprises:
a covering belt for transporting the pastries/dough pieces from a dough receiving point to a dispensing point, such that, at the dough receiving point, pastries or dough pieces not covered on their bottoms can be received on the covering belt and, at the dough dispensing point, pastries or dough pieces coated on their bottoms can be dispensed by the covering belt, such that the pastries or dough pieces can be transported in a transport plane of the covering belt from the dough receiving point to the dough dispensing point and such that the covering belt is fed back to the dough receiving point in a return plane below the dough transport plane of the covering belt,
a dispersible-material unit for receiving and applying the dispersible or scatterable material, said unit being arranged below the transport plane,
a transport belt, such that the transport belt is arranged at least partly below the dispersible- or scatterable-material unit and such that dispersible or scatterable material can be applied to the transport belt by the dispersible- or scatterable-material unit.

The present teaching foresees that, between the return plane and the transport plane of the covering belt, the covering belt and the transport belt are arranged at a distance, in particular an adjustable distance, from each other or in contact with each other in a transfer region in such a way that dispersible or scatterable material can be clamped between the covering belt and the transport belt and, in the transfer region, can be transferred from the transport belt onto the covering belt. In the transfer region, the transport belt is arranged so as to follow the course of the covering belt, in particular on the outside with respect to the return of the covering belt.

The inventive device allows a particularly compact structure, cleaning is substantially simplified and in addition selective application of dispersible and scatterable material on pastries/dough pieces becomes possible. Definite reduction of spatial demands is possible thanks to the inventive arrangement. The transport belt and the covering belt are partly arranged above one another, so that space can be saved. In the transfer region the transport belt and the covering belt are arranged in such a way that dispersible and scatterable material can be transported upward contrary to the direction of gravity. Because the dispersible material is clamped between the transport belt and the covering belt in the transfer region, the dispersing pattern is maintained and selective and uniform dispersal can be achieved, so that the dispersible material beyond the transfer region is further transported on the covering belt.

The distance between the covering belt and the transport belt is greater within the transfer region than ahead of and beyond the transfer region. In particular for the application of different dispersible or scatterable material, it can be foreseen that in the transfer region the distance between the covering belt and the transport belt is adjustable, so that the distance can be adapted to the kernel size of the currently used dispersible material, and thus the dispersible or scatterable material can be clamped in a particularly protective way.

Advantageous refinements are obtained as a result of the following features:

To achieve particularly selective scattering, it can be foreseen that the covering belt at the upper end of the transfer region comprises an incline of at most 60°, in particular of 0° to 30°, preferably of 0° to 10°. Slippage of the dispersible or scatterable material on the covering belt is thereby avoided. The incline is determined as the angle formed between the covering belt and the strict horizontal in the region following the transfer region in the flow direction of the covering belt.

To make especially protected transmission possible along with small space demands, it can be foreseen that in the transfer region the covering belt and the transport belt are each fed in a common arc. Here the radius of the arc described by the covering belt is smaller than or equal to the radius of the arc described by the transport belt.

Especially uniform distribution of the dispersible or scatterable material can be achieved if in the transfer region the covering belt and the transport belt are each fed in a circular arc. It can thus be foreseen that the circular arcs described by the covering belt and transport belt comprise the same centerpoint and a common centerpoint angle of at least 90°, preferably at least 170°. In this manner the dispersible or scatterable material can be clamped particularly easily and the dispersible or scatterable material can be transferred from the transport belt to the covering belt with particular precision.

With different radii of the circular arcs, the distance between the covering belt and the transport belt corresponds to the width of the circular ring.

In addition, it can be foreseen that the covering belt partly, particularly at least in the transfer region, is arranged to proceed around a drum, such that the circumference of the drum determines the circular arc described by the covering belt.

It is possible, thereby, in an advantageous manner from the structural viewpoint, to obtain exact feeding of the covering belt in the transfer region, so that controlled transfer of the dispersible or scatterable material is possible and any random bouncing of the dispersible or scatterable material can be even more fully avoided. In particular, the drum can comprise a diameter that makes it possible that in the transfer region a major part of the difference in height between the portion of the transport belt arranged below the dispersible-material unit and the dough receiving point can be overcome.

It can be foreseen, in addition, that the wrap-around angle of the covering belt around the drum is equal to at least 180°. This makes a compact structure possible, allowing the covering belt to be fed over just two deflections, so that cleaning is facilitated. In particular, the wrap-around angle can be at least 200°. The deflections around which the covering belt is fed thus comprise a varied diameter, so that, first, the transfer region becomes as large as possible in order to allow precise transfer of the dispersible or scatterable material and, second, the space required for the covering belt is kept as small as possible in order to allow a compact structure. For example, at least partial arrangement of the dispersible- or scatterable-material unit can be achieved below the dough dispensing unit, supporting especially compact structure for the device.

Particularly compact structure for the device is made possible if the diameter of the drum corresponds at least to the height of the dispersible-material unit. Because the dispersible-material unit comprises a particular structural height because of its function, it is necessary to transport the dispersible or scatterable material from the height of application onto the transport belt at the height of the dough receiving point, such that this can become possible in the transfer region by means of the drum.

A particularly stable and compact configuration of the device can be achieved if the drum is configured as a driving drum of the covering belt.

To make exact feeding of the transport belt in the transfer region possible, it can be foreseen that the transport belt in the transfer region is fed by way of deflection rollers, said deflection rollers comprising a contrary running direction to the covering belt, in particular to the drum of the covering belt. In particular, it can be foreseen that the deflection rollers are arranged in such a way that the transport belt is fed in the arc, in particular in the circular arc. This allows exact transport of the dispersible or scatterable material. Transmission of the dispersible or scatterable material can occur in a particularly protected manner if the running speed of the transport belt corresponds to the running speed of the covering belt. The dispersible or scatterable material here is transported in such a controlled manner that particularly controlled, for instance uniform, scattering can occur.

To make protected transmission of the dough pieces possible, the transport belt can be fed in the running direction of the transport belt at the end of the transfer region by way of a deflection roller configured as a blade edge. Thanks to the blade edge it becomes possible to arrange the dough pieces' receiving point at a minimal transmission angle, The transmission angle can be further reduced if the covering belt comprises a slight rise. In addition, by configuring the final deflection roller in the transfer region as a blade edge, the transfer region can be kept particularly short by an interposed installation component, so that compact construction of the device is made possible. In addition, cleaning of the transport belt can be facilitated if the transport belt in the running direction of the transport belt comprises a blade edge at the end of the transfer region or includes an arranged deflection roller, such that the blade edge or deflection roller is arranged on a pivotable mounting in such a way that the transport belt can be slackened by pivoting the deflection roller.

To allow particularly compact construction of the device, it can be foreseen that the dispersible- or scatterable-material unit is arranged below the transport plane in such a way that excess dispersible or scatterable material that has not been received by the dough pieces trickles off at the end of the transport plane, so that it is foreseen in particular that the covering belt at the dough dispensing point is fed by way of a covering belt deflection roller. As a result of this arrangement, excess dispersible or scatterable material, by taking advantage of gravity, can be fed back into the dispersible-material unit without additional energy usage. To make it simple to avoid spreading of the dispersible material within the device, it can be foreseen that in the running direction of the covering belt, beyond the covering belt deflection roller, a dispersible-material remover is foreseen, so that excess dispersible or scatterable material can be moved from the covering belt into the dispersible-material unit.

This arrangement makes it possible for an automated operation to dispense with a return unit for returning the dispersible or scatterable material. In customary installations, which foresee reuse of the excess dispersible material, feedback using vacuum, blower, screw conveyor unit and/or other conveyor belts becomes necessary. Cleaning such return units is difficult, because the cleaning of hoses, valves, pumps, screw conveyor installations, conveyor belt units and blowers is frequently impossible to perform sufficiently and can cause enormous costs.

Thanks to the avoidance of the return unit for the dispersible- or scatterable-material unit, the high energy consumption as well as the cleaning expense necessary for known return devices is, on the whole, no longer required.

Thus, if the dispersible- or scatterable-material unit is arranged in such a way that the dispersible or scatterable material trickling down from the covering belt, directly obeying gravity, lands in the dispersible or scatterable material, a compact, easily cleanable, energy- and cost-efficient device can be achieved.

The energy requirement can also be kept low if provisions are made so that the dispersible- or scatterable-material unit includes a dispersible- or scatterable-material container for receiving the dispersible or scatterable material that is to be applied and a dispersal device arranged below the dispersible- or scatterable-material container in the direction of gravity for applying the dispersible or scatterable material. In addition, this allows the structure to be highly compact in shape.

To avoid spreading of the scatterable material, in addition, it is possible to foresee that an additional transport unit is provided, which is arranged so that, at the dough dispensing point, dough pieces can be dispensed from the covering belt to the other transport unit, so that it is foreseen in particular that between the covering belt and the other transport unit an intermediate space is provided, which is configured in such a way that dispersible or scatterable material situated on the covering belt can be transported through the intermediate space between the covering belt and the other transport unit.

To be able to prevent spreading of dispersible or scatterable material still better, it can be foreseen that the device, in particular as an additional transport unit, comprises a trickling unit for ridding the dough pieces of poorly adhering scatterable material, so that at the dough dispensing point the dough pieces can be dispensed from the covering belt to the trickling unit, so that the trickling unit is configured in such a way that poorly adhering scatterable material can be removed, and so that it can be provided, in particular, that removed dispersible or scatterable material can be incorporated into the scatterable-material unit. A grid tape, in particular, can be foreseen as the trickling unit. In this way, excess dispersible or scatterable material can be removed effectively.

It can be foreseen that, between the dough receiving and dough dispensing points, a pressure roller is arranged above the covering belt so that dough pieces situated on the covering belt can be pressed onto the dispersible or scatterable material by the pressure roller, and in particular it is foreseen that the distance between the pressure roller and covering belt is adjustable. The dispersible or scatterable material can thereby be pressed deeper into the dough pieces and thus can be better affixed on the dough pieces. In this way, in particular, especially uniform and substantial dispersal can be achieved. In addition, in part, preliminary moistening of the dough pieces becomes unnecessary, so that cleaning the device is simplified.

In order to make possible particularly simple cleaning, one-sided flush mounting of the transport units can be foreseen. Such a mounting can thus be foreseen either for the covering belt, the transport belt or the trickling unit, or else for several or all such components. It can preferably be foreseen in this case that all mountings are arranged on the same side of the device, in particular in the running direction of the coating belt close to the device, in order to configure cleaning in particularly simple manner. The mounting can, in addition, be configured on a withdrawable rod. Thus, in particular, stable mounting is assured, which nevertheless makes simple cleaning possible.

To make cleaning of the transport belt even simpler, it can be foreseen that the transport belt is arranged on a frame, with the frame mounted in such a way that it can be removed from the device, in particular perpendicularly to the running direction of the covering belt. Cleaning of the other components can also be facilitated in this way. To remove the frame from the device, the frame can be equipped with pivoting wheels. This makes it possible to slide the frame perpendicularly to the running direction of the transport belt.

The present teaching also foresees a dough installation with at least one device as previously described. Thanks to the compact construction of the device, the space demanded for a dough installation can be considerably reduced.

It is also possible for the dough installation to include a scattering device for scattering from above, which is arranged in such a way that dough pieces can have material applied to them on both sides without requiring any rotating motion. Rotation of dough pieces is particularly prone to problems with delicate dough pieces, because the shape of such pastries must be maintained during rotation. Such difficulties can be overcome with an arrangement according to the present teaching.

Alternatively, or in addition, it is possible to foresee that, for two-sided dispersal of material on dough pieces, the dough installation includes two devices as previously described, such that the devices are so arranged that rotation of the dough pieces occurs between the devices. As a result, particularly compact structure becomes possible.

A particularly advantageous embodiment of the present teaching is presented with reference to the following drawings by way of example, without restricting the general inventive concept.

### BRIEF DESCRIPTION OF THE DRAWINGS

FIG. 1 shows an exemplary device in combination with a device for scattering from above, with the arrangement seen in cross-section.

FIG. 2 shows the arrangement from FIG. 1 in a lateral view.

FIG. 3 shows the arrangement from FIG. 1 in an overhead view.

FIG. 4 shows an exemplary device seen in a first diagonal view.

FIG. 5 shows an exemplary device from FIG. 4 from a second diagonal view.

FIG. 6 shows the device from FIG. 4 in a lateral view.

FIG. 7 shows the device from FIG. 4 in an overhead view.

FIG. 8 shows the device from FIG. 4 with the frame and transport belt removed.

FIG. 9 shows a first diagonal view of the arrangement from FIG. 8.

FIG. 10 shows a second diagonal view of the arrangement from FIG. 8.

FIG. 11, for the arrangement from FIG. 4, shows the transport belt on a slidable frame.

FIG. 12 shows the arrangement from FIG. 11 in a diagonal view.

FIG. 13 shows the arrangement from FIG. 11 from the rear.

FIG. 14 shows the arrangement from FIG. 11 in a lateral view.

FIG. 15, for the arrangement from FIG. 11, shows a section along the axis A-A (FIG. 16).

FIG. 16 shows the arrangement from FIG. 11 from above.

FIG. 17 shows the transport belt of the arrangement from FIG. 4.

FIG. 18 shows the transport belt from FIG. 17 from above.

FIG. 19 shows the transport belt from FIG. 17 in a first diagonal view

FIG. 20 shows the transport belt from FIG. 17 in a second diagonal view.

FIG. 21 shows the transport belt from FIG. 17 in exploded form.

FIG. 22 shows the transport belt from FIG. 17 in exploded form from above,

FIG. 23 shows the transport belt from FIG. 17 in exploded form in a first lateral view.

FIG. 24 shows the transport belt from FIG. 17 in exploded form in a second lateral view.

### DETAILED DESCRIPTION

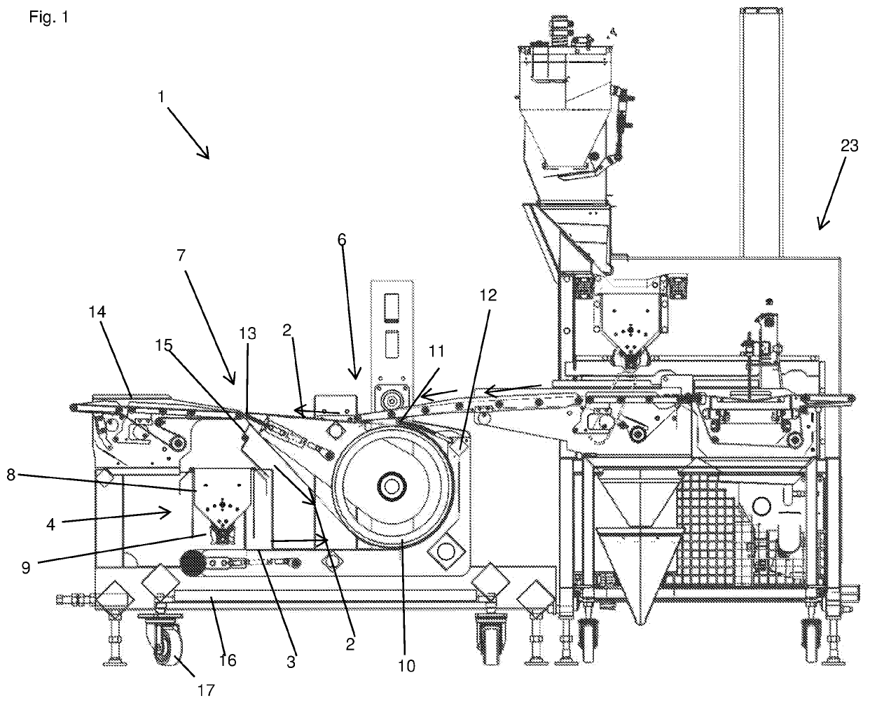

Shown in FIG. 1 is a combination consisting of an inventive device 1 and a scattering device 23 for scattering from above. It thus makes two-sided scattering of dough pieces possible without rotation. The inventive device 1 includes a covering belt 2, a transport belt 3 and a dispersible-material unit 4. The covering belt 2 and the transport belt 3 are belt movers or conveyor belts, which in the illustrated embodiment are continuously welded. They can be manufactured advantageously as elastic rubber belts or with smooth or structured surface or with elastic or soft coating.

The covering belt 2 is fed around a drum 10 and a covering belt deflection roller 13. The upper run of the covering belt 2 runs from the drum 10 to the covering belt deflection roller 13 and determines the transport plane. The lower run of the covering belt 2 runs from the covering belt deflection roller 13 to the drum 10 and determines the return plane. Between the return plane and the transport plane, a transfer region 5 is provided, in which the transport belt 3 is arranged on the outside with respect to the return of the covering belt 2.

At the same time, a part of the transport belt 3, close to the covering belt 2, is positioned as following the course of the drum 10, such that the distance between transport belt 3 and covering belt 2 is uniform. Preceding and following the transfer region 5, the distance between transport belt 3 and covering belt 2 is greater than in the transfer region 5. In the transfer region 5, the covering belt 2 and transport belt 3 are fed in a common arc, so that the covering belt 2 and the transport belt 3 are each arranged in a circular arc with the same centerpoint, and such that the distance between the covering belt 2 and transport belt 3 corresponds to the width of the associated circular ring. Dispersible material is transported on the transport belt 3 to the transfer region 5 and clamped in the transfer region 5 between the transport belt 3 and the covering belt 2 and transported upward. In the process, the dispersible material is transferred from the transport belt 3 to the covering belt 2. At the upper end point of the transfer region 5, the covering belt 2 comprises a rise of 5°. In the illustrated embodiment, the transport plane, or the upper run of the covering belt 2, generally comprises a rise of 5°.

The dough pieces that are to have material applied are received on the covering belt 2 in the running direction of the covering belt 2 beyond the transfer region 5. Dough pieces are transferred by the covering belt 2 in the transport plane from the dough receiving point 6 to a dough dispensing point 7. At the dough dispensing point 7, the covering belt 2 runs over the covering belt deflection roller 13. There the dough pieces are dispensed by the covering belt 2.

Excess dispersible or scatterable material, obeying gravity, falls off the covering belt 2. This excess dispersible or scatterable material is caught by the dispersible-material unit 4, because said dispersible-material unit 4 is arranged below the transport plane. In the illustrated embodiment, the dispersible-material unit 4 is arranged partly below the covering belt deflection roller 13. The dispersible-material unit 4 is suitable for the reception and dispensing of the dispersible or scatterable material. The transport belt 3 runs in a section that is arranged in the running direction of the transport belt 3 before the transfer region 5, below the dispersible-material unit 4. In this section, dispersible material is applied by the dispersible-material unit 4 onto the transport belt 3.

In the illustrated embodiment, the dispersible-material unit 4 is mounted on a base unit of the device. The dispersible-material unit 4 comprises a dispersible-material container 8 and a dispersal device 9 arranged inside the dispersible-material container 8. The dispersible-material container 8 is suitable for receiving dispersible or scatterable material that is to be applied.

In the illustrated embodiment, the dispersible-material container 8 can be withdrawn from the dispersible-material unit 4. To replace used dispersible or scatterable material, it is possible, for example, to provide a screw conveyor unit, which conveys dispersible material from a storage container into the dispersible-material container 8. The dispersal device 9 serves to remove the dispersible or scatterable material from the dispersible-material container 8 onto the transport belt 3.

The dispersible or scatterable material is applied by the dispersal device 9 onto the receiving region of the transport belt 3 or is dispersed from above out of the dispersal device 9 onto the transport belt 3. It is possible here to obtain a minimal drop height for the dispersible or scatterable material and thus to avoid, to the maximum extent possible, any random bouncing of the dispersible or scatterable material during application onto the transport belt 3. In the transfer region 5 the dispersible material is transferred from the transport belt 3 onto the covering belt 2 and transported from the covering belt 2 to the dough dispensing unit 7. In the illustrated embodiment, the dispersible-material container 8 is arranged below the covering belt deflection roller 13. Dispersible or scatterable material falling from the covering belt 2 onto the covering belt deflection roller 13, lands, by force of gravity, in the dispersible-material container 8 and can be retrieved in the dispersible-material container 8 and thus reused.

Dough pieces are taken up at the dough receiving unit 6, so that preferably dough pieces without material applied on their bottom are taken up onto the covering belt 2. In the illustrated embodiment, a transmission hook is mounted between the foregoing dispersal device 23 for dispersing from above and the device 1. Said hook makes possible the non-twisted, protective transmission of dough pieces. In the illustrated embodiment, the transmission hook can be situated above the drum 10. As a result of this arrangement, the device 1 can be of compact construction, while at the same time protective treatment of the dough pieces also becomes possible.

The dough pieces are thus placed in contact with the dispersible or scatterable material that is already present on the covering belt 2. The dispersible material is thus pressed into the dough pieces by their own weight and remains attached to them. Depending on the characteristics of the dough, it is possible either to provide for preliminary moistening of the dough pieces or to dispense with moistening. To improve adhesion of the dispersible or scatterable material, one can foresee the arrangement of a pressure roller, not illustrated, above the covering belt 2. Thanks to this pressure roller, the dispersible or scatterable material can be pressed deeper into the dough pieces and thus adheres even better to them.

In the illustrated embodiment, the dough pieces with material dispersed on the bottom are transmitted at the dough dispensing unit 7 to another transport unit 14. The additional transport unit 14 takes the form of a trickling-off unit or of a grid tape. Dispersible or scatterable material not adhering to the dough pieces and therefore superfluous is not transmitted to the additional transport unit 14 at the dough dispensing unit 7 but instead falls off the covering belt 2. The dispersible or scatterable material thus comes directly into the dispersible-material container 8, which is arranged below the dough dispensing unit 7.

To prevent dispersible or scatterable material from being dragged with the covering belt 2 inside the device 1, a dispensable-material remover 15 is foreseen, which is arranged beyond the covering belt deflection roller 13 in the covering belt 2 running direction. The dispensable-material remover 15 is constructed of multiple parts so that it is at least partly removable, and cleaning can be facilitated. Alternatively, a one-piece removable dispersible-material remover 15 can be provided. Thanks to the dispersible-material remover 15, dispersible or scatterable material removed from the covering belt 2 falls into the dispersible-material container 8.

To avoid the dragging of dispersible or scatterable material even better, poorly adhering dispersible or scatterable material is removed from the dough pieces with the trickling unit during transport of the dough pieces. This removed dispersible or scatterable material is also retrieved in the dispersible-material container 8. The trickling unit is arranged on the base unit of the device 1 in the illustrated embodiment. The trickling unit comprises an input hook, which is movable in the longitudinal direction. This makes it possible to adapt to the belt tension of the covering belt 2, and the trickling unit is arranged with an adjustable intermediate space for the covering belt deflection roller 13. This arrangement makes it possible for dispersible or scatterable material to fall through the intermediate area between the covering belt 2 and the trickling unit and allows dragging of dispersible or scatterable material to be avoided. The belt body of the trickling unit is removable, or can be withdrawn from the device 1. In the illustrated embodiment, power is supplied by a breakable coupling. In an alternative embodiment, a motor with or without breakable connection can be provided as the power drive for the trickling unit.

It can be recognized in FIG. 1 that the inventive device 1 has a clearly reduced spatial requirement in comparison with the known dispersal device 23 for scattering from above. Thanks to the compact structure, in addition, cleaning of the device 1 is clearly facilitated. The movable components of the device 1 are bolted together with the base unit of the device 1.

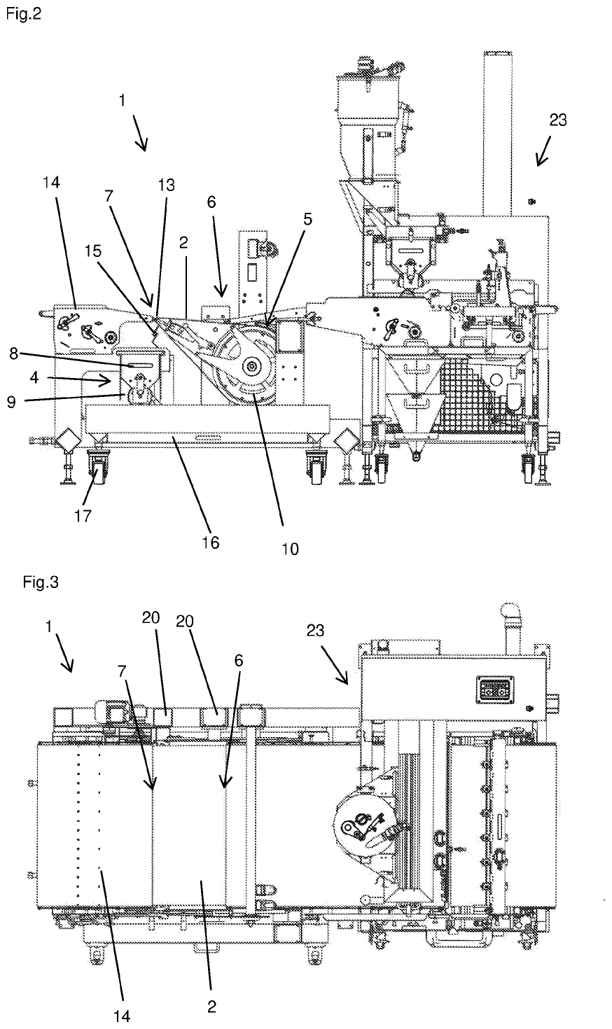

FIG. 2 shows that the transport belt 3 is mounted on a frame 16. The frame 16 can be slid by pivot wheels 17, making it possible to remove the frame 16 from the device 1, such that sliding out of the device 1 perpendicular to the running direction of the transport belt 3 becomes possible. Cleaning of the device 1 is thereby facilitated. The pivot wheels 17 can be configured as either braked or non-braked.

In FIG. 3 it can be recognized that the device 1 is constructed in such a way that the covering belt 2, the trickle unit and the transport belt 3 are mounted flush on one side. The bearings 20 in the illustrated embodiment are all arranged to the right in the running direction of the covering belt 2 from the dough receiving unit 6 to the dough dispensing unit 7. Because of the one-sided mounting, cleaning is simplified. At the same time, mounting on a withdrawable rod is also foreseen in the illustrated embodiment.

It can be recognized in FIG. 5 that the opposite side of the mounting is secured with a fixing screw 19. To also ensure stable structure at greater belt widths, it is possible for the free ends to be supported.

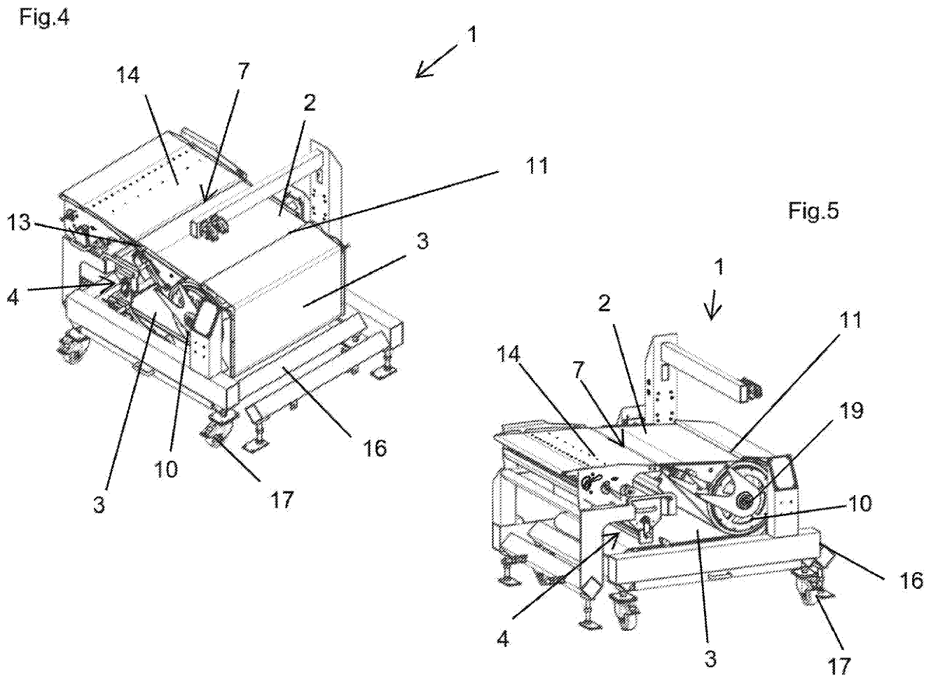

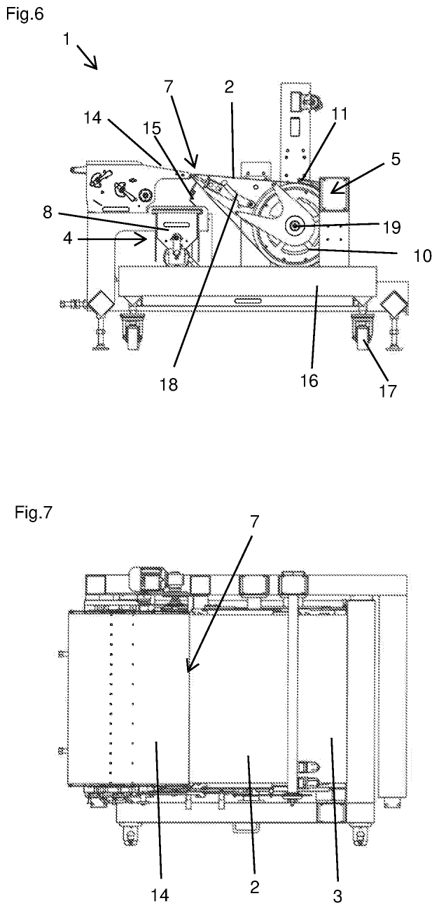

FIGS. 4 through 7 depict the device 1 in isolated position. It can be recognized that the transport belt 3 at the end of the transfer region 5 comprises a deflection roller 12 configured as a blade edge 11. The blade edge 11 makes flat arrangement of the transmission hook possible and is thus advantageous for protective transmission of the dough pieces.

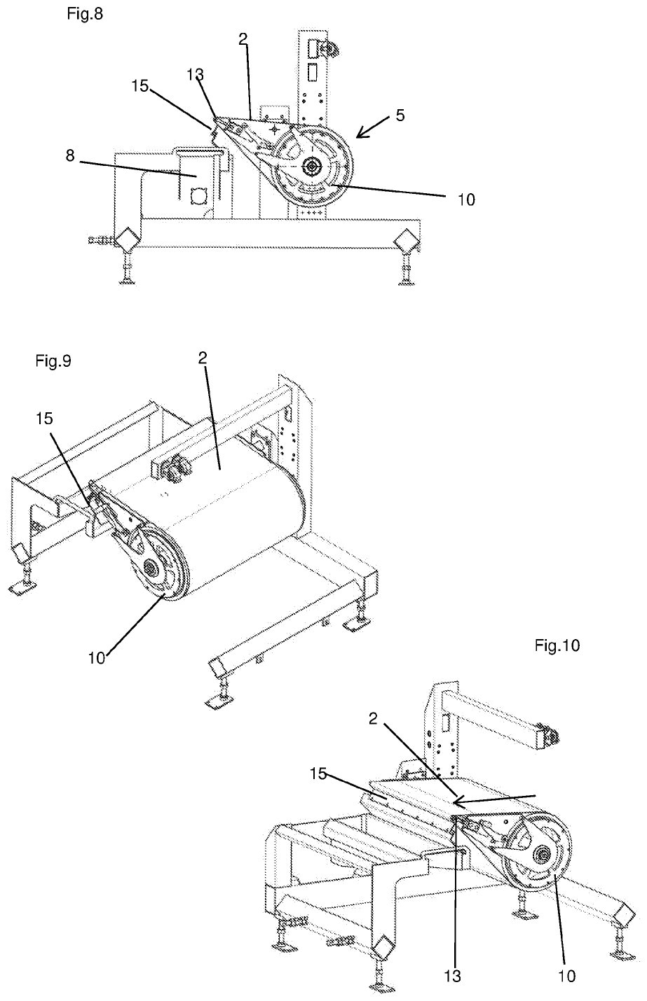

In FIGS. 8 through 10 the covering belt 2 and the suspension of the covering belt 2 are shown as a single component. In the illustrated embodiment, the covering belt 2 is secured to the base unit of the device 1. The base element can be linked by adjustable connections with preceding and following components of the installation. For example, connection by threaded spindles can be foreseen.

In the illustrated embodiment the covering belt 2 is mounted flush on one side. The covering belt 2 is fed in the transfer region 5 around the drum 10 in a circular arc. In the illustrated embodiment the drum 10 is mounted on a rod on the belt body, so that cleaning becomes particularly simple owing to the releasable connection and even at greater nominal widths sufficient stability can be achieved. By loosening the fixer screws 19 it is possible to withdraw the drum 10 from the rod.

The drum 10 in the illustrated embodiment has a diameter of 430 mm. The drum 10 is the driver drum of the covering belt 2. The wrap-around angle of the covering belt 2 about the drum 10 is greater than 180°. The covering belt 2, in addition, is fed over the covering belt deflection roller 13. Particularly advantageous here is a symmetrical-angle spanning of the covering belt 2 to reduce the burden on the mounting of the covering belt deflection roller 13. The transport plane and the return plane in the illustrated embodiment form an angle of 45°.

The covering belt 2 has a running direction in which the upper run of the covering belt 2 is moved by the drum 10 to the covering belt deflection roller 13. In the illustrated embodiment the covering belt 2 in the transfer region moves at an angle of 5′ from the horizontal, making possible the particularly protective issuing of the dough pieces from the transmission hook to the covering belt 2. It can be arranged that the angle of the covering belt 2 or its inclination from the horizontal is adjustable and, for example, that the covering belt 2 runs horizontally in this region.

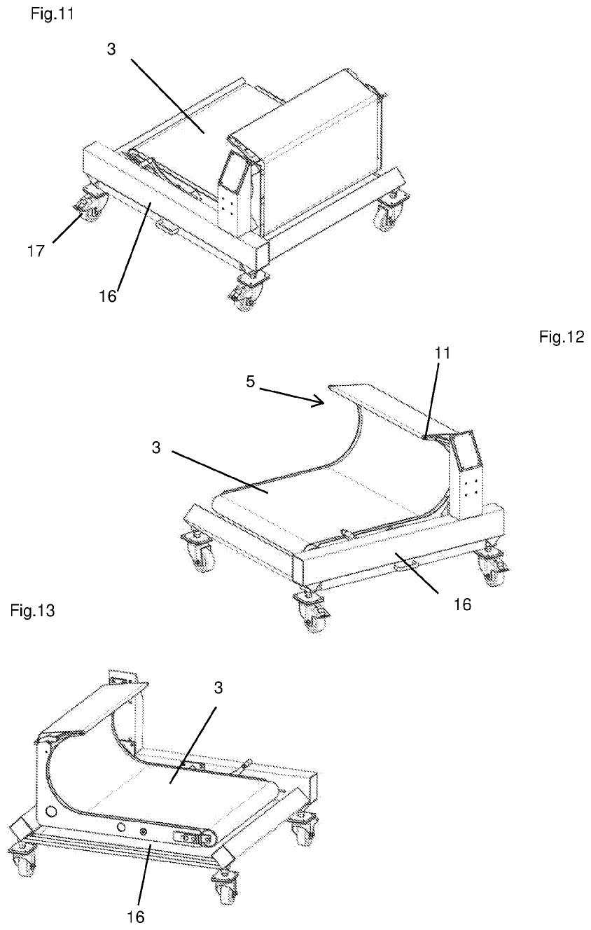

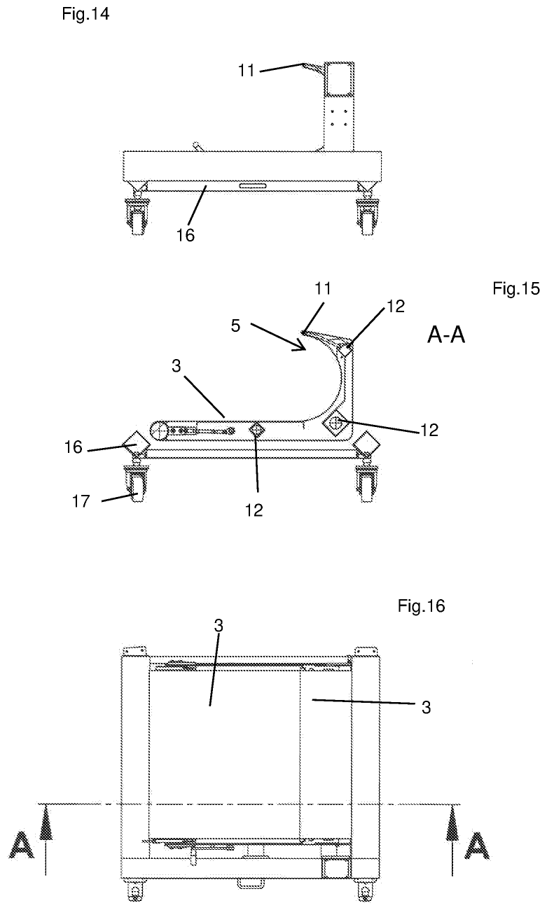

In the illustrated embodiment the covering belt deflection roller 13 is fed in the lateral shield by means of gliding parts and can be moved by a knee lever 18. By moving the knee lever 18, the covering belt 2 can be slackened and thus withdrawn from the drum 10 and the covering belt deflection roller 13, to provide simpler cleaning of the components including the transport belt and covering belt. FIGS. 11 through 14 indicate how the transport belt 3 is arranged on the slidable frame 16. In an alternative embodiment it is possible for the transport belt 3 not to be mounted on a slidable frame, and thus the other components of the device 1 can be lifted or lowered for cleaning.

In the illustrated embodiment the transport belt 3 is fed over deflection rollers 12. It can be advantageous if a belt mounting supports the transport belt 3 as far as the start of the transfer region 5. In the transfer region 5 the transport belt 3 is fed over three deflection rollers 12, which make possible an arrangement in a circular arc. The circular arc follows the course of the drum 10. Here the transport belt 3 is arranged so that the circular arc has a centerpoint angle of 175°. As a result of arranging the transport belt 3 close to the covering belt 2, dispersible or scatterable material can be clamped between the covering belt 2 and the transport belt 3 and transported upward. For this purpose, in the device 1 the covering belt 2 and the transport belt 3 are arranged in such a way that in the transfer region 5 the distance between the covering belt 2 and the transport belt 3 is adjustable and essentially corresponds to the grain size of the dispersible or scatterable material. The dispersible material here can be, for example, poppy seeds, sesame seeds, oats or other dispersible or scatterable material customary in bakery enterprises. The drum 10 of the covering belt 2 and the deflection roller 12 of the transport belt 3 comprise a contrary running direction; the covering belt 2 in the illustrated embodiment runs in clockwise direction and the transport belt 3 in counterclockwise direction. As a result, in the transfer region the dispersible or scatterable material can be protectively transported upward.

Arranged at the end of the transfer region 5 is the topmost deflection roller 12 of the transport belt 3, which is configured as a blade edge 11. At this point, optionally, a remover can be provided in order to avoid dragging the dispersible or scatterable material along the transport belt 3 beyond the transfer region 5. Because of the blade edge 11, the end of the transfer region 5 is configured flat, so that the transmission hook from the preceding installation components can be arranged at a flat angle to the covering belt 2 to make protective dispensing of the dough pieces possible.

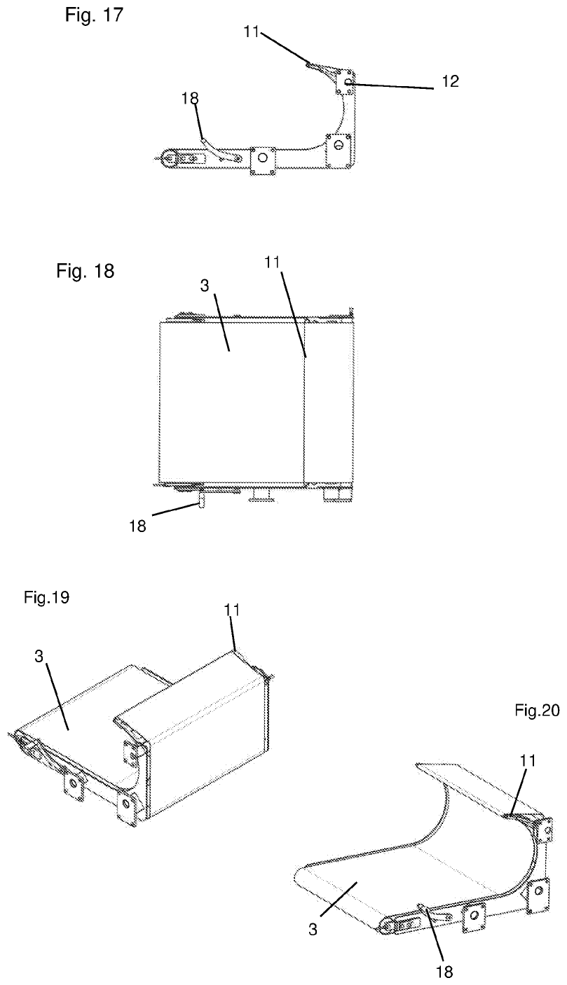

FIGS. 16 through 19 show the transport belt 3 without the frame 16. In the illustrated embodiment the transport belt 3 is fed over a total of five deflection rollers and powered by a driver drum. This driver drum can be configured as a drum motor, with slip-on motor or with mechanical drive by means of belts, chains or coupling. In the illustrated embodiment the driver drum is shown as a drum motor and functions simultaneously as an expansion shaft. Tensing or slackening of the transport belt 3 occurs by means of knee lever 18. Alternatively other known tensing elements can be used. In the illustrated embodiment the reception of the driver drum in the lateral shield occurs by means of the gliding parts. The belt body is mounted flush on one side, so that, after slackening of the tensing and power shaft, the transport belt 3 can easily be withdrawn from the belt body.

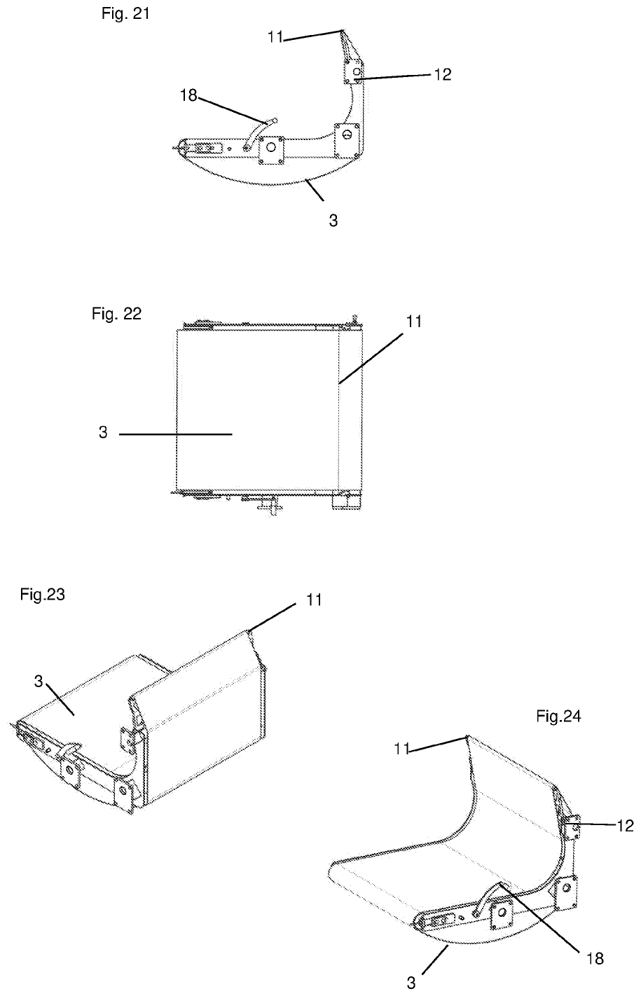

FIGS. 20 through 23 show the transport belt 3 in slackened position. By activating the knee gear 18, the blade edge 11 is pivoted upward by one rotation position. Thanks to this pivoting of the blade edge 11, the transport belt 3 is slackened. This facilitates disassembly, belt replacement and cleaning of the device.

The inventive device 1 therefore makes possible the precise dispersal of dough pieces with a compact installation component that is, in particular, easily to clean.

1. A device for applying dispersible or scatterable material to the bottom of dough pieces, including:
a covering belt for transporting the pieces of dough from a dough receiving point to a dough dispensing point, wherein it is possible to receive pieces of dough not sprinkled on the bottom thereof onto the covering belt at the dough receiving point and to dispense pieces of dough sprinkled on the bottom thereof from the covering belt at the dough dispensing point, wherein it is possible to transport the pieces of dough in a transport plane of the covering belt from the dough receiving point to the dough dispensing point, and the covering belt being led back to the dough receiving point in a return plane below the transport plane of the covering belt,
a scatterable-material unit for receiving and applying the scatterable or dispersible material,
a transport belt, wherein the transport belt is arranged at least partly below the scatterable-material unit, and wherein it is possible to apply dispersible or scatterable material to the transport belt by the scatterable-material unit,
wherein the scatterable-material unit is arranged below the transport plane, and, between the return plane and the transport plane of the covering belt, the covering belt and transport belt in a transfer region are at a distance from each other or in contact with each other in such a way that scatterable or dispersible material can be clamped between the covering belt and the transport belt and, in the transfer region, can be transferred from the transport belt onto the covering belt and wherein in the transfer region the transport belt is arranged so as to follow the course of the covering belt.

2. The device according to claim 1, wherein the covering belt on the upper endpoint of the transfer region includes a rise of 60° at a maximum.

3. The device according to claim 1, wherein in the transfer region the covering belt and transport belt are each fed in a common arc.

4. The device according to claim 3, wherein in the transfer region the covering belt and transport belt are each fed in a circular arc, such that it is provided that the circular arcs described by the covering belt and transport belt include the same centerpoint and a common centerpoint angle of at least 90°.

5. The device according to claim 1, wherein the covering belt at least in part is arranged to run about a drum, such that the circumference of the drum determines a circular arc described by the covering belt and wherein in particular it is foreseen that the wrap-around angle of the covering belt about the drum is at least 180°, and/or wherein the drum is configured as a driver drum of the covering belt.

6. The device according to claim 5, wherein the diameter of the drum corresponds at least to the height of the scatterable-material unit.

7. The device according to claim 1, wherein the transport belt in the running direction of the transport belt at the end of the transfer region includes a blade edge or includes an arranged deflection roller, wherein the blade edge or deflection roller is arranged on a pivotable mounting in such a way that the transport belt can be slackened by pivoting the deflection roller.

8. The device according to claim 1, wherein the scatterable-material unit is mounted below the transport plane in such a way that excess dispersible or scatterable material trickles off at the end of the transport plane from the covering belt into the scatterable-material unit, wherein the covering belt at the dough dispensing point is fed over a covering belt deflection roller and beyond the covering belt deflection roller a scatterable-material remover is provided, so that excess dispersible or scatterable material can be moved from the covering belt into the scatterable-material unit.

9. The device according to claim 1, wherein the scatterable-material unit includes a scatterable-material container for receiving the dispersible or scatterable material that is to be applied, along with a scattering device, arranged in the direction of gravity below the scatterable-material container, for applying the scatterable material.

10. The device according to claim 1, wherein an additional transport is arranged so that, at the dough dispensing point, dough pieces can be dispensed from the covering belt to the additional transport unit, so that between the covering belt and the other transport unit, an intermediate space is provided, which is configured so that dispersible or scatterable material situated on the covering belt can be transported, and in particular can trickle down, through the intermediate space between the covering belt and the other transport unit.

11. The device according to claim 1, wherein the device includes a trickle-down unit to clear the dough pieces of poorly adhering dispersible or scatterable material, so that at the dough dispensing point the dough pieces can be dispensed from the covering belt to the trickle-down unit, while the trickle-down unit is configured so that poorly adhering scatterable or dispersible material can be removed, and that removed dispersible material can be received in the dispersible-material unit.

12. The device according to claim 1, wherein, between the dough receiving point and the dough dispensing point, a pressure roller is arranged above the covering belt so that dough pieces situated on the covering belt can be pressed onto the dispersible or scatterable material by the pressure roller and wherein it is provided that the distance between the pressure roller and the covering belt is adjustable.

13. The device according to claim 1, wherein the covering belt and/or the transport belt and/or the trickle-down unit, flush on one side, are mounted near the device in the running direction of the covering belt, so that all bearings are arranged on the same side of the device, and wherein the mounting is configured on a withdrawable rod.

14. The device according to claim 1, wherein the transport belt is arranged on a frame, wherein the frame, is mounted so that it can be removed from the device, and wherein it can slide.

15. A dough installation with at least one device according to claim 1,
wherein, it is provided that the dough installation includes a scattering device for scattering from above, which is arranged in such a way that dough pieces can be sprinkled on both sides without twisting,
and/or wherein the dough installation includes two devices, wherein the devices are arranged in such a way that twisting of the dough pieces is between the devices.
